(19) United States
(12) Patent Application Publication
(10) Pub. No.: US 2025/0125460 A1
(43) Pub. Date: Apr. 17, 2025

(54) SUPPORT STRUCTURE

(71) Applicant: Merry Electronics(Shenzhen) Co., Ltd., ShenZhen (CN)

(72) Inventors: Ting Hsuan Lin, Taichung (TW); Jen Chieh Cheng, Taichung (TW); Feng-Ping Chang, Taichung (TW)

(73) Assignee: Merry Electronics(Shenzhen) Co., Ltd., ShenZhen (CN)

(21) Appl. No.: 18/507,096

(22) Filed: Nov. 13, 2023

(30) Foreign Application Priority Data
Oct. 13, 2023 (TW) 112139107

(51) Int. Cl. H01M 50/207; H01M 50/262

(52) U.S. Cl. CPC H01M 50/207; H01M 50/262

(57) ABSTRACT

A support structure including a first bracket, a second bracket, and at least one elastic member is provided. The first bracket includes multiple first alignment hole groups. The second bracket is detachably connected to the first bracket along a first axis. The second bracket includes multiple second alignment hole groups. The second bracket is adapted to slide relative to the first bracket along the first axis to change a length of the support structure along the first axis. The at least one elastic member is detachably connected to the first bracket and the second bracket. When the second bracket is connected to the first bracket, at least one of the first alignment hole groups is aligned with at least one of the second alignment hole groups to form at least one insertion space. A portion of the at least one elastic piece is located in the corresponding at least one insertion space and connected to the first bracket and the second bracket.

### CROSS-REFERENCE TO RELATED APPLICATION

This application claims the priority benefit of Taiwan application serial no. 112139107, filed on Oct. 13, 2023. The entirety of the above-mentioned patent application is hereby incorporated by reference herein and made a part of this specification.

### BACKGROUND

### Technical Field

The disclosure relates to a structure, and more particularly, to a support structure.

### Description of Related Art

An internal space of a device nowadays may not be necessarily utilized properly, leaving an excess space (i.e., the space where elements are not disposed). The excess spaces will reduce structural strength of the device, making it easy to deform due to impact when the device is dropped. Nowadays, a method used to fill the excess spaces to enhance the structural strength is to fill the excess spaces with filling materials such as foam. Specifications of general filling materials are limited. When filling a larger space, multiple layers are required to be stacked, and the volume is required to be large enough, so as to absorb the impact of dropping, which is inconvenient for use.

For example, a battery box of a bicycle may contain multiple batteries, and an internal space of the battery box is designed according to different types of batteries. Depending on usage requirements, the actual number of batteries disposed in the battery box may be less than the maximum capacity of the battery box, and an excess space in the battery box (i.e., the space where the batteries are not disposed) will affect the overall structural strength of the battery box. When the foam is used to fill the excess space, a large amount of foam is required to be stacked in multiple layers, which increases the difficulty of disposition. In addition, when the foam is disposed in the battery boxes corresponding to different types of batteries, the foam is required to be redesigned to correspond to different spaces, which is inconvenient for use.

### SUMMARY

The disclosure provides a support structure that may be switched between multiple sizes for ease of use.

A support structure in the disclosure includes a first bracket, a second bracket, and at least one elastic member. The first bracket includes multiple first alignment hole groups. The second bracket is detachably connected to the first bracket along a first axis. The second bracket includes multiple second alignment hole groups. The second bracket is adapted to slide relative to the first bracket along the first axis to change a length of the support structure along the first axis. At least one elastic member is detachably connected to the first bracket and the second bracket. When the second bracket is connected to the first bracket, at least one of the first alignment hole groups is aligned with at least one of the second alignment hole groups to form at least one insertion space, and a portion of each of the at least one elastic member is located in the corresponding at least one insertion space and connected to the first bracket and the second bracket.

Based on the above, the second bracket of the support structure in the disclosure may move relative to the first bracket to change the length of the support structure along the first axis. The support structure may be switched between multiple sizes to improve the convenience of use of the support structure. The elastic member is configured to connect the first bracket and the second bracket, and fix the first bracket and the second bracket.

### BRIEF DESCRIPTION OF THE DRAWINGS

FIG. 1 is an exploded view of a support structure according to an embodiment of the disclosure.

FIG. 2 is a schematic view of the support structure in FIG. 1 in a first state.

FIG. 3 is a cross-sectional view of the support structure in FIG. 2.

FIG. 4 is another cross-sectional view of the support structure in FIG. 2.

FIG. 5 is a schematic view of the support structure in FIG. 1 in a second state.

FIG. 6 is a cross-sectional view of the support structure in FIG. 5.

FIG. 7 is another cross-sectional view of the support structure in FIG. 5.

FIG. 8 is a schematic view of the support structure in FIG. 1 in a third state.

FIG. 9 is a cross-sectional view of the support structure in FIG. 8.

FIG. 10 is another cross-sectional view of the support structure in FIG. 8.

### DETAILED DESCRIPTION OF DISCLOSED EMBODIMENTS

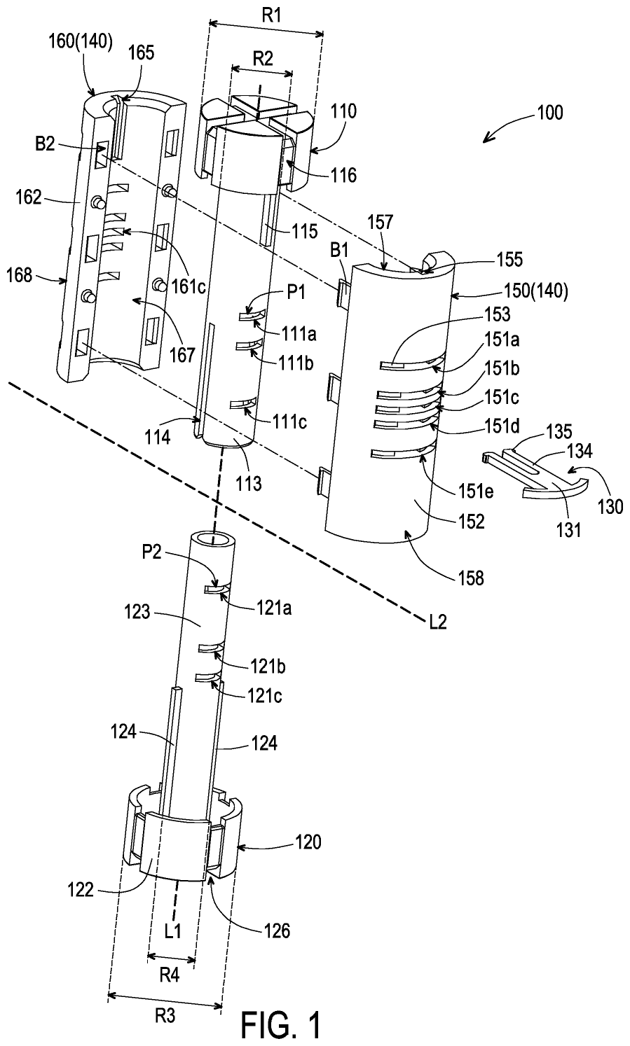

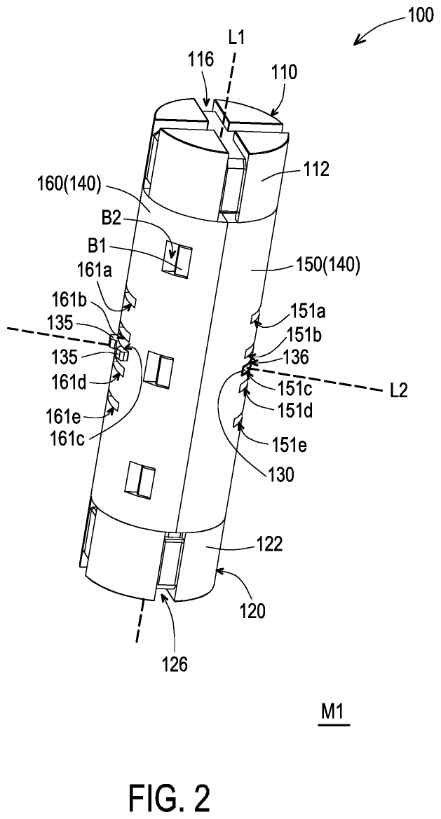

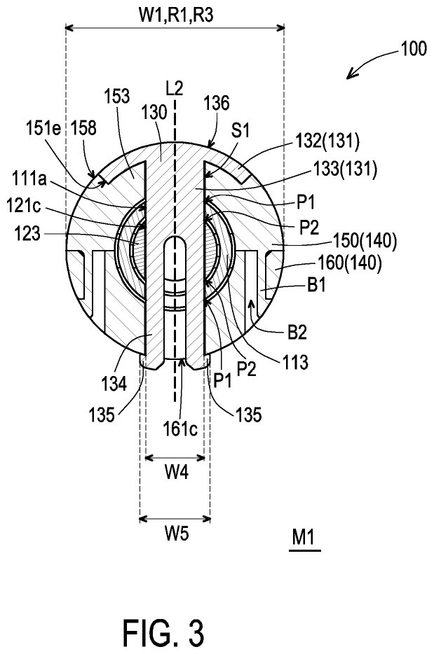

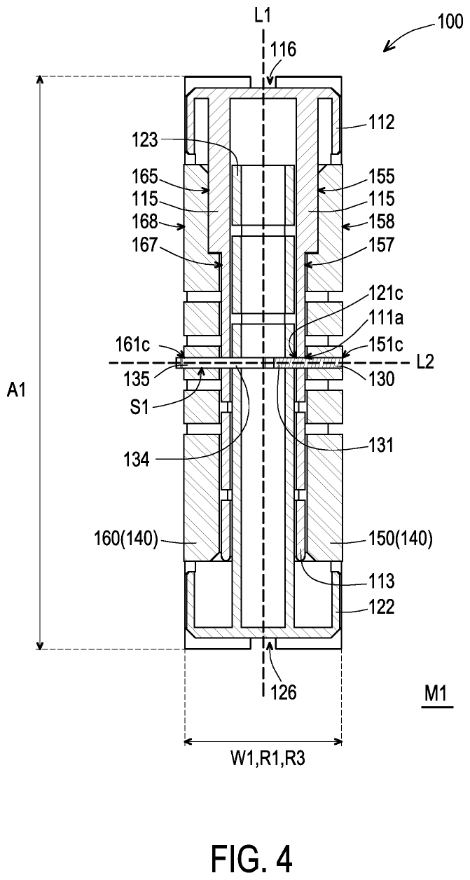

FIG. 1 is an exploded view of a support structure according to an embodiment of the disclosure. FIG. 2 is a schematic view of the support structure in FIG. 1 in a first state. FIG. 3 is a cross-sectional view of the support structure in FIG. 2. FIG. 4 is another cross-sectional view of the support structure in FIG. 2. Referring to FIGS. 1 to 4 together, a support structure 100 includes a first bracket 110, a second bracket 120, and at least one elastic member 130. The second bracket 120 is detachably connected to the first bracket 110 along a first axis L1. The first bracket 110 includes multiple first alignment hole groups 111a, 111b, and 111c, and the second bracket 120 includes multiple second alignment hole groups 121a, 121b, and 121c. In this embodiment, the number of first alignment hole groups 111a, 111b, and 111c is three, and the number of second alignment hole groups 121a, 121b, and 121c is three. However, the disclosure is not limited thereto.

As shown in FIG. 3, each of the first alignment hole groups 111a, 111b, and 111c includes two first openings P1 disposed corresponding to each other along a second axis L2, and each of the second alignment hole groups 121a, 121b, and 121c includes two second openings P2 disposed corresponding to each other along the second axis L2. The first axis L1 is perpendicular to the second axis L2. The second bracket 120 may slide relative to the first bracket 110 along the first axis L1 to change a length of the support structure 100 along the first axis L1.

When the second bracket 120 is connected to the first bracket 110 such that at least one of the three first alignment hole groups 111a, 111b, and 111c is aligned with at least one of the three second alignment hole groups 121a, 121b, and 121c, the first alignment hole group and the second alignment hole group aligned with each other form at least one insertion space S1. A portion of the elastic member 130 is detachably inserted into the insertion space S1 formed by the first bracket 110 and the second bracket 120 along the second axis L2 to be connected to the first bracket 110 and the second bracket 120, thereby fixing a length A1 (FIG. 4) of the support structure 100 along the first axis L1.

The support structure 100 may be disposed in a device (not shown) to fill an excess space inside an electronic device, so as to enhance overall structural strength of the device. The support structure 100 in this embodiment may be switched between three states, so that the support structure 100 has three different lengths. However, the disclosure is not limited thereto. The support structure 100 may be adapted to different situations by switching between different lengths, thereby improving convenience of use of the support structure 100.

As shown in FIGS. 1 and 3, the first bracket 110 includes a first head portion 112 and a first neck portion 113 connected to each other, and the second bracket 120 includes a second head portion 122 and a second neck portion 123 connected to each other. Shapes of the first head portion 112, the first neck portion 113, the second head portion 122, and the second neck portion 123 are, for example, cylindrical shapes. The first alignment hole groups 111a, 111b, and 111c (the first opening P1) are located at the first neck portion 113, and the second alignment hole groups 121a, 121b, and 121c (the second opening P2) are located at the second neck portion 123.

A width R1 of the first head portion 112 along the second axis L2 (i.e., a diameter of the first head portion 112) is greater than a width R2 of the first neck portion 113 along the second axis L2 (i.e., a diameter of the first neck portion 113). A width R3 of the second head portion 122 along the second axis L2 (i.e., a diameter of the second head portion 122) is greater than a width R4 of the second neck portion 123 along the second axis L2 (i.e., a diameter of the second neck portion 123). The width R2 of the first neck portion 113 is larger than the width R4 of the second neck portion 123, so that the second neck portion 123 is detachably connected to the first neck portion 113 along the first axis L1. When the second bracket 120 is connected to the first bracket 110, the second neck portion 123 is connected to the first neck portion 113, and at least a portion of the second neck portion 123 is disposed through the first neck portion 113.

As shown in FIG. 1, the width R1 of the first head portion 112 is equal to the width R3 of the second head portion 122, so that two opposite ends of the support structure 100 have the same width. The first bracket 110 includes at least a first limiting groove 114, and the second bracket 120 includes at least a first limiting member 124. The number of first limiting grooves 114 in this embodiment is two. FIG. 1 schematically illustrates one first limiting groove 114. The number of first limiting members 124 corresponds to the number of first limiting grooves 114 and is two.

The first limiting groove 114 is a groove extending from an end of the first neck portion 113 away from the first head portion 112 along the first axis L1 toward the first head portion 112. The first limiting member 124 is connected to the second neck portion 123. When the second bracket 120 is connected to the first bracket 110, at least a portion of the first limiting member 124 is located in the corresponding first limiting groove 114 to prevent the second bracket 120 from rotating relative to the first bracket 110, and may guide the second bracket 120 to move relative to the first bracket 110 along the first axis L1.

As shown in FIGS. 1 and 2, the support structure 100 optionally includes an auxiliary member 140, and the auxiliary member 140 is detachably connected to the first neck portion 113 of the first bracket 110. The auxiliary member 140 includes multiple first auxiliary apertures and multiple second auxiliary apertures. In this embodiment, the number of first auxiliary apertures 151a, 151b, 151c, 151d, and 151e is five, and the number of second auxiliary apertures 161a, 161b, 161c, 161d, and 161e is five. However, the disclosure is not limited thereto. The first auxiliary apertures 151a, 151b, 151c, 151d, and 151e correspond to the second auxiliary apertures 161a, 161b, 161c, 161d, and 161e. When the auxiliary member 140 is connected to the first bracket 110, and the second bracket 120 is connected to the first bracket 110, the first neck portion 113 of the first bracket 110 is located between the auxiliary member 140 and the second neck portion 123 of the second bracket 120. The auxiliary member 140 is configured to enhance structural strength of the support structure 100.

The auxiliary member 140 in this embodiment includes a first auxiliary member 150 and a second auxiliary member 160. The first auxiliary member 150 and the second auxiliary member 160 are detachably connected to the first neck portion 113 of the first bracket 110 along the second axis L2. When the first auxiliary member 150 and the second auxiliary member 160 are connected to the first bracket 110, at least a portion of the first bracket 110 is located between the first auxiliary member 150 and the second auxiliary member 160.

As shown in FIGS. 3 and 4, the first auxiliary member 150 includes a first body 152. The first auxiliary apertures 151a, 151b, 151c, 151d, and 151e are located in the first body 152 of the first auxiliary member 150 and are specifically sinking holes. The second auxiliary member 160 includes a second body 162. These second auxiliary apertures 161a, 161b, 161c, 161d, and 161e are located in the second body 162 of the second auxiliary member 160 and are specifically through holes. The first body 152 and the second body 162 correspond to shapes of the first bracket 110 and the second bracket 120 and are respectively semi-cylinders. The first auxiliary member 150 and the second auxiliary member 160 are connected to multiple corresponding slots B2 through multiple hooks B1, for example. These hooks B1 are connected to the first body 152, and the slots B2 are located in the second body 162. However, the disclosure is not limited thereto.

The first bracket 110 includes two second limiting members 115. The first auxiliary member 150 includes a second limiting groove 155. The second auxiliary member 160 includes a third limiting groove 165. The two second limiting members 115 are connected to one end of the first neck portion 113 adjacent to the first head portion 112, but the disclosure is not limited thereto. The two second limiting members 115 extend along the first axis L1. The second limiting groove 155 is a recess that is recessed from an inner surface 157 of the first body 152 of the first auxiliary member 150 to an outer surface 158. The third limiting groove 165 is a recess that is recessed from an inner surface 167 of the second body 162 of the second auxiliary member 160 to an outer surface 168. The second limiting groove 155 and the third limiting groove 165 correspond to the second limiting member 115 and extend along the first axis L1. When the auxiliary member 140 is connected to the first bracket 110 (the first neck portion 113), one second limiting member 115 is at least partially located in the second limiting groove 155, and another second limiting member 115 is at least partially located in the third limiting groove 165, so as to prevent the auxiliary member 140 (the first auxiliary member 150 and the second auxiliary member 160) from rotating relative to the first bracket 110.

As shown in FIGS. 3 and 4, when the auxiliary member 140 is connected to the first bracket 110 (the first neck portion 113), and the second bracket 120 (the second neck portion 123) is connected to the first bracket 110, the at least one of the three first alignment hole groups 111a, 111b, and 111c, the at least one of the three second alignment hole groups 121a, 121b, and 121c, at least one of the five first auxiliary apertures 151a, 151b, 151c, 151d, and 151e, and at least one of the second auxiliary apertures 161a, 161b, 161c, 161d, and 161e are aligned with one another to form the corresponding insertion space S1. The elastic member 130 may be inserted into the corresponding insertion space S1. In this way, the elastic member 130 may be configured to fix the first bracket 110, the second bracket 120, and the auxiliary member 140 (the first auxiliary member 150 and the second auxiliary member 160).

As shown in FIG. 4, each of the elastic member 130 includes an elastic member body 131, two elastic arms 134, and two hook portions 135. The two elastic arms 134 are connected to the elastic member body 131, and the two hook portions 135 are respectively connected to the corresponding two elastic arms 134. The two hook portions 135 may be engaged with the auxiliary member 140. The elastic member body 131 includes a first portion 132 and a second portion 133 that are connected. The first portion 132 corresponds to a shape and size of the first auxiliary aperture 151c (the first auxiliary member 150), and the second portion 133 corresponds to shapes and sizes of the first alignment hole group 111a (the first bracket 110) and the second alignment hole group 121c (the second bracket 120).

The two elastic arms 134 are connected to the second portion 133 of the elastic member body 131. The two elastic arms 134 have a certain degree of elasticity. A maximum width W4 between the two elastic arms 134 corresponds to a width of the second auxiliary aperture 161c. The two hook portions 135 are located at one end of the elastic arm 134 away from the second portion 133 (the elastic member body 131). A maximum width W5 between the two hook portions 135 is greater than the maximum width W4 between the two elastic arms 134, and is greater than the width of the second auxiliary aperture 161c, so that the two hook portions 135 of the elastic member 130 may be engaged with the second auxiliary member 160 (the auxiliary member 140).

FIGS. 2 to 4 illustrate the support structure 100 in a first state M1. As shown in FIGS. 2 to 4, in the first state M1, the second neck portion 123 of the second bracket 120 completely extends into the first neck portion 113 of the first bracket 110, and the first limiting member 124 is completely located in the first limiting groove 114 (FIG. 1), so that one first alignment hole group 111a and one second alignment hole group 121c are aligned on the second axis L2. The second limiting member 115 of the first bracket 110 is completely located in the second limiting groove 155 of the first auxiliary member 150, and the other second limiting member 115 of the first bracket 110 is completely located in the third limiting groove 165 of the second auxiliary member 160.

Lengths of the first auxiliary member 150 and the second auxiliary member 160 along the first axis L1 corresponds to a length of the first neck portion 113 along the first axis L1. At this time, the first neck portion 113 and the second neck portion 123 are completely located between the first auxiliary member 150 and the second auxiliary member. The first alignment hole group 111a, the second alignment hole group 121c, the first auxiliary aperture 151c, and the second auxiliary aperture 161c are aligned on the second axis L2 to form the insertion space S1. One elastic member 130 is inserted into the corresponding insertion space S1, so that the support structure 100 is fixed in the first state M1.

As shown in FIGS. 2 and 3, during a process of the elastic member 130 being inserted into the first bracket 110 (the first neck portion 113), the second bracket 120 (the second neck bracket 123), and the auxiliary member 140 (the first auxiliary member 150 and the second auxiliary member 160), the two hook portions 135 of the elastic member 130 are pushed against each other by the first bracket 110, the second bracket 120, the first auxiliary member 150, and the second auxiliary member 160 to approach each other, thereby driving the two elastic arms 134 to bend, so that the elastic member 130 may move in the insertion space S1. When the elastic member 130 moves to a position (FIG. 3), the two elastic arms 134 return to the position in FIG. 3 by the elastic force thereof. The elastic member body 131 of the elastic member 130 and the two elastic arms 134 are located in the corresponding insertion space S1, and the two hook portions 135 are exposed from the second auxiliary aperture 161c to the auxiliary member 140 (the second auxiliary member 160) and are engaged with the auxiliary member 140. In this way, the elastic member 130 is stably connected to the first bracket 110, the second bracket 120, and the auxiliary member 140 to fix the first bracket 110, the second bracket 120, and the auxiliary member 140.

As shown in FIG. 3, the first portion 132 of the elastic member body 131 is located in the first auxiliary aperture 151c, and the first portion 132 abuts an inner wall 153 of the first auxiliary aperture 151c to prevent the elastic member 130 from further moving along the second axis L2 and fix the elastic member 130 in the position of FIG. 3. The first portion 132 of the elastic member body 131 includes an outer surface 136. A radian of the outer surface 136 corresponds to a radian of the outer surface 158 of the first auxiliary member 150, whereby an appearance of the support structure 100 may be maintained beautiful. The second portion 133 of the elastic member body 131 extends into the first auxiliary member 150, the first bracket 110, and the second bracket 120. The two elastic arms 134 extend into the first bracket 110, the second bracket 120, and the second auxiliary member 160.

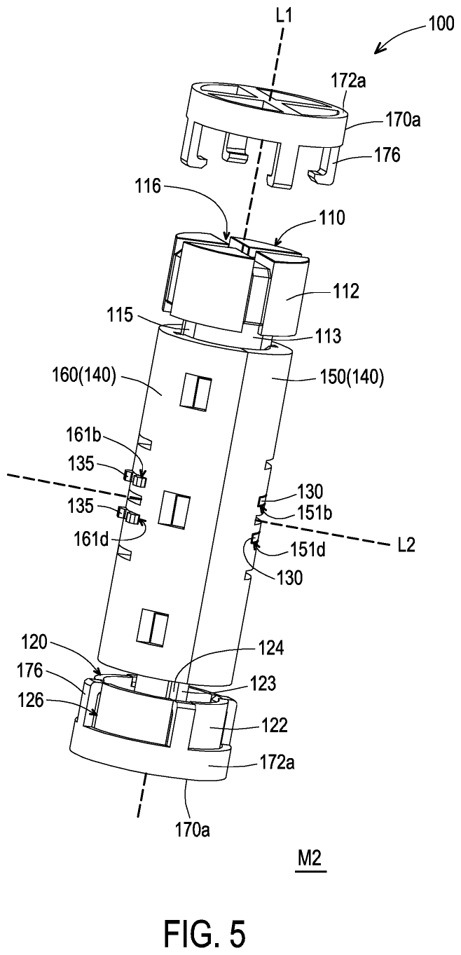

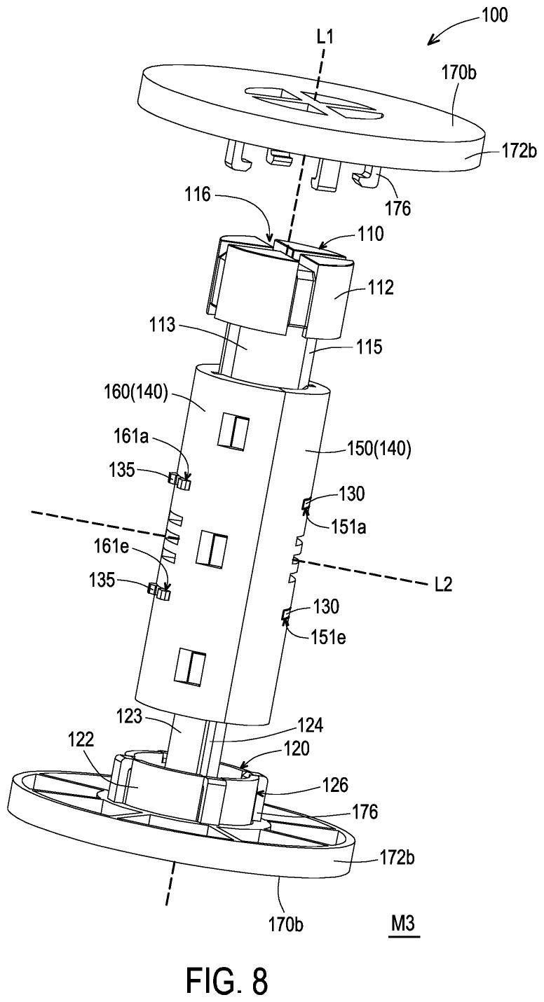

When the support structure 100 is to be switched from the first state M1 to another state (described later), the two hook portions 135 of the elastic member 130 may receive the force to approach each other and be disengaged from the second auxiliary member 160. Then, the elastic member 130 may be taken out along the second axis L2, so that the elastic member 130 is separated from the insertion space S1. After the elastic member 130 is separated from the insertion space S1, the first bracket 110 and the second bracket 120 may move along the first axis L1 relative to the first auxiliary member 150 and the second auxiliary member 160, and the first bracket 110 and the second bracket 120 may move relative to each other, so that the support structure 100 is switched to a second state M2 (FIG. 5) or a third state M3 (FIG. 8).

As shown in FIG. 4, the support structure 100 in this embodiment is in a cylindrical shape as a whole. The length A1 of the support structure 100 in the first state M1 along the first axis L1 is, for example, 65 mm, and a maximum width W1 of the support structure 100 along the second axis L2 is, for example, 18 mm. However, the disclosure is not limited thereto. The length A1 and the maximum width W1 of the support structure 100 are the same as a cylindrical battery of model 18650, and may be disposed in a device (for example, a battery box) for loading the cylindrical battery, so as to fill the space inside the device to enhance the structural strength of the device.

For example, a commercially available battery box may hold ten cylindrical batteries of model 18650. In actual applications, depending on requirements of a user, the battery box may only hold four cylindrical batteries of model 18650. At this time, the user may install six support structures 100 in the first state M1 into the battery box to fill an idle space of the battery box and enhance structural strength of the battery box.

In addition, since the battery box fixes the cylindrical battery (the support structure 100) by engaging two opposite ends of the cylindrical battery (the support structure 100) through an internal fixing member, as long as the two ends of the support structure 100 (e.g., the first head portion 112 and the second head portion 123) conform to sizes of the two ends of the cylindrical battery, the support structure 100 may be stably fixed in the battery box.

A configuration of the elements of the support structure 100 is not limited to this embodiment. In an embodiment not shown, only the first bracket 110, the second bracket 120, and the elastic member may be used for the support structure. A shape and size of the elastic member correspond to the first alignment hole group and the second alignment hole group, and may be firmly engaged with the first bracket 110 and the second bracket 120. Since a size of the first head portion 112 of the first bracket 110 and a size of the second head portion 123 of the second bracket 120 match the two ends of the cylindrical battery of model 18650, the support structure may still be disposed in the battery box.

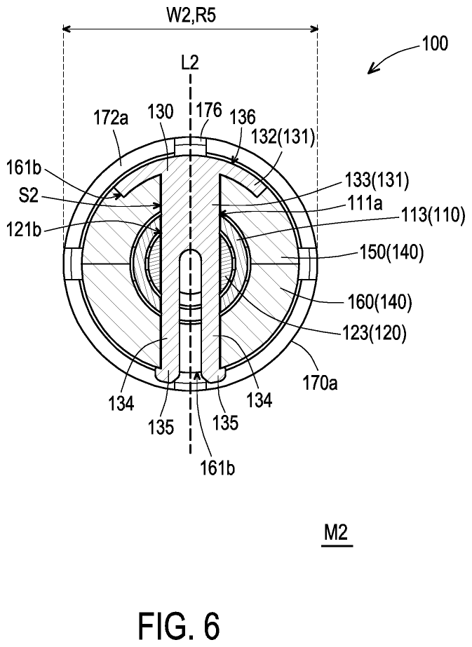

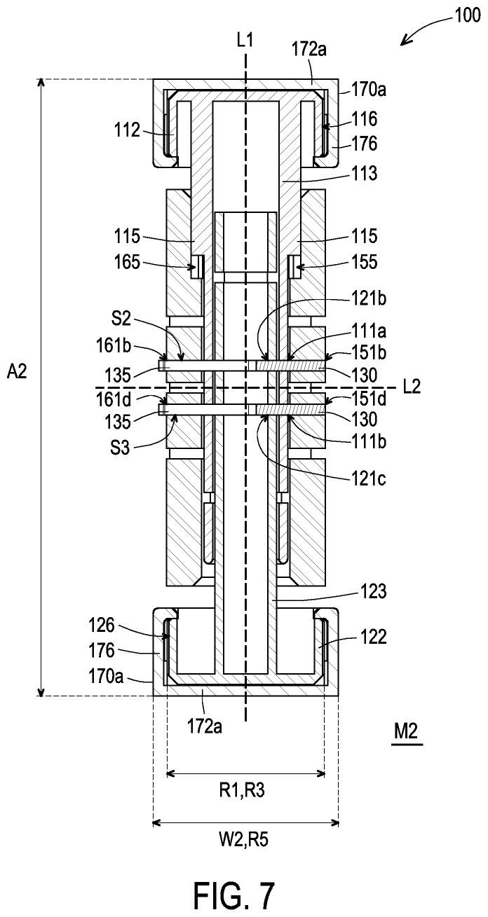

FIG. 5 is a schematic view of the support structure in FIG. 1 in a second state. FIG. 6 is a cross-sectional view of the support structure in FIG. 5. FIG. 7 is another cross-sectional view of the support structure in FIG. 5. Referring to FIGS. 5 to 7, the user may relatively move the first bracket 110 and the second bracket 120 along the first axis L1 to a position in FIG. 5, so that the support structure 100 is in the second state M2. In the second state M2, a portion of the second neck portion 123 the second bracket 120 extends into the first neck portion 113 of the first bracket 110. The second limiting member 115 of the first bracket 110 is partially located in the second limiting groove 155 of the first auxiliary member 150, and the other second limiting member 115 of the first bracket 110 is partially located in the third limiting groove 165 of the second auxiliary member 160.

As shown in FIG. 7, the first alignment hole group 111a, the second alignment hole group 121b, the first auxiliary aperture 151b, and the second auxiliary aperture 161b are aligned to form an insertion space S2. The first alignment hole group 111b, the second alignment hole group 121c, the first auxiliary aperture 151d, and the second auxiliary aperture 161d are aligned to form an insertion space S3. The two elastic members 130 are inserted into the two insertion spaces S2 and S3 respectively, so that the support structure 100 may be in the second state M2 more stably. The length A1 (FIG. 4) of the support structure 100 in the first state M1 along the first axis L1 is less than a length A2 of the support structure 100 in the second state M2 along the first axis L1.

As shown in FIG. 5, the support structure 100 further includes two expansion members 170a. The two expansion members 170a are connected to the first bracket 110 and the second bracket 120 respectively. Each of the expansion member 170a includes an expansion body 172a and multiple engaging members 176. The engaging member 176 is connected to the expansion body 172a. The expansion body 172a is, for example, a cylinder. The number of engaging members 176 is, for example, four, but the disclosure is not limited thereto. The first head portion 112 of the first bracket 110 has multiple corresponding engaging grooves 116, and the second head portion 123 of the second bracket 120 has multiple corresponding engaging grooves 126. The engaging members 176 of the two expansion members 170a are respectively engaged with the engaging grooves 116 and 126 of the first bracket 110 and the second bracket 120, so that the two expansion members 170a are connected to the first bracket 110 (the first head portion 112) and the second bracket 120 (the second head portion 122) respectively.

As shown in FIG. 7, a width R5 of the expansion body 172a of the expansion member 170a along the second axis L2 (i.e., a diameter of the expansion body 172a) is greater than the width R1 of the first head portion 112 (the first bracket 110) along the second axis L2, and is greater than the width R3 of the second head portion 123 (the second bracket 120) along the second axis L2. In this way, a maximum width W2 of the support structure 100 along the second axis L2 may be changed. The maximum width W2 of the support structure 100 is the width R5 of the expansion member 170a.

The support structure 100 is in the second state M2, and the first bracket 110 and the second bracket 120 are engaged with the two expansion members 170a. The length A2 thereof along the first axis L1 is 70 mm, and the maximum width W2 along the second axis L2 is 21 mm, and corresponds to a cylindrical battery of model 21700. The two expansion bodies 172a of the two expansion members 170a of the support structure 100 may be engaged with the fixing member of the battery box.

In addition, in an embodiment not shown, the two expansion members 170a may be connected to the first bracket 110 and the second bracket 120 in the first state M1, thereby changing a size of appearance of the support structure 100.

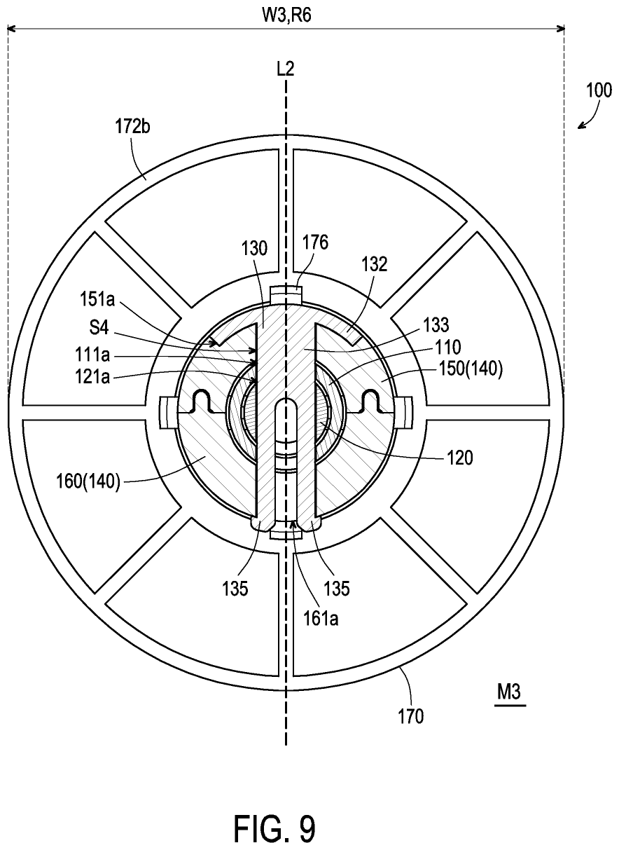

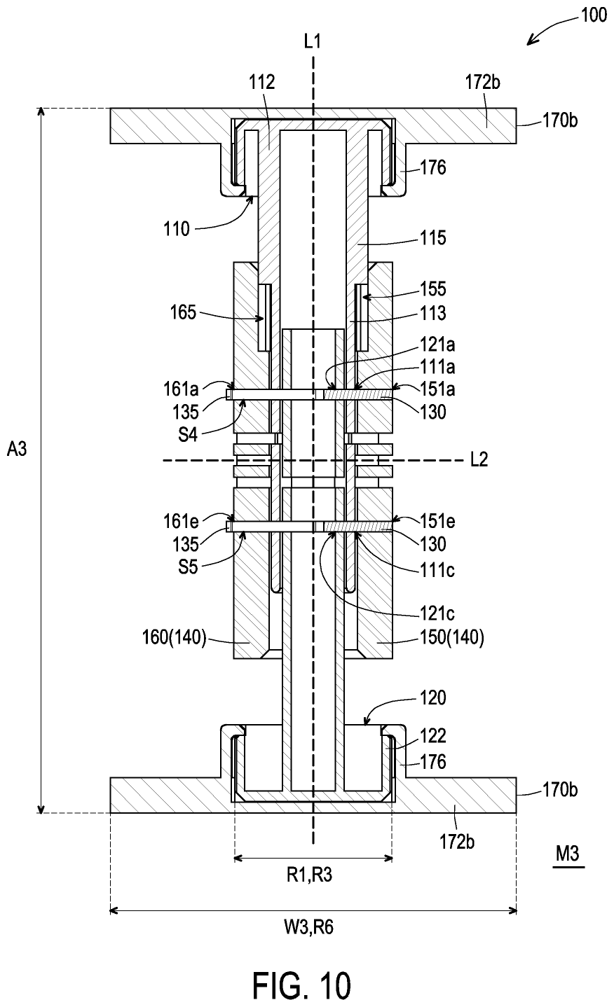

FIG. 8 is a schematic view of the support structure in FIG. 1 in a third state. FIG. 9 is a cross-sectional view of the support structure in FIG. 8. FIG. 10 is another cross-sectional view of the support structure in FIG. 8. Referring to FIGS. 8 to 10, the user may relatively move the first bracket 110 and the second bracket 120 along the first axis L1 to a position in FIG. 8, so that the support structure 100 is in the third state M3. In the third state M3, the second neck portion 123 of the second bracket 120 partially extends into the first neck portion 113 of the first bracket 110.

As shown in FIG. 10, the first alignment hole group 111a, the second alignment hole group 121a, the first auxiliary aperture 151a, and the second auxiliary aperture 161a are aligned to form an insertion space S4. The first alignment hole group 111c, the second alignment hole group 121c, the first auxiliary aperture 151e, and the second auxiliary aperture 161e are aligned to form an insertion space S5. The two elastic members 130 are respectively disposed in the two insertion spaces S4 and S5, so that the support structure 100 may be in the third state M3 more stably. The length A2 (FIG. 7) of the support structure 100 in the second state M2 along the first axis L1 is less than a length A3 of the support structure 100 in the third state M3 along the first axis e L1.

A width R6 (i.e., a diameter of an expansion body 172b) of the expansion body 172b of an expansion member 170b in this embodiment along the second axis L2 is greater than the width R5 of the expansion member 170a (FIG. 6), so as to further change the maximum width W3 of the support structure 100 along the second axis L2. The maximum width W3 of the support structure 100 is the width R6 of the expansion member 170b.

The support structure 100 is in the third state M3, and the first bracket 110 and the second bracket 120 are engaged with the two expansion members 170b. The length A3 thereof along the first axis L1 is 80 mm, and the maximum width W3 is 46 mm, and corresponds to a cylindrical battery of model 46800. The two expansion members 170b of the support structure 100 may be engaged with the fixing member of the battery box.

As a result, the support structure 100 may change the length of the support structure 100 along the first axis L1 through the relative movement of the first bracket 110 and the second bracket 120 along the first axis L1. The support structure 100 may change the maximum width of the support structure 100 along the second axis L2 through the expansion members 170a and 170b. In this way, the support structure 100 in this embodiment may have similar size of appearance to the cylindrical batteries of model 18650, model 21700, and model 46800, and may be disposed in the corresponding battery box, so as to provide good support and enhance the structural strength of the battery box.

In addition, the sizes of the first bracket 110, the second bracket 120, and the auxiliary member 140 and the number of alignment holes (the first alignment hole group, the second alignment hole group, the first auxiliary aperture, and the second auxiliary aperture) are not limited to this embodiment, and the width of the extension member is not limited to this embodiment. The size of appearance that the support structure 100 may form is not limited to this embodiment. For example, in other embodiments, the support structure may have similar sizes of appearance to the cylindrical batteries of model 10400, model 14500, model 32650, etc., and may be used in the corresponding battery box.

Based on the above, the second bracket of the support structure in the disclosure may move relative to the first bracket to change the length of the support structure along the first axis. The support structure may be switched between multiple sizes to improve the convenience of use of the support structure. The elastic member is configured to connect the first bracket and the second bracket, and fix the first bracket and the second bracket.

What is claimed is:

1. A support structure, comprising:
a first bracket comprising a plurality of first alignment hole groups;
a second bracket detachably connected to the first bracket along a first axis, wherein the second bracket comprises a plurality of second alignment hole groups, and the second bracket is adapted to slide relative to the first bracket along the first axis to change a length of the support structure along the first axis; and
at least one elastic member detachably connected to the first bracket and the second bracket,
wherein when the second bracket is connected to the first bracket, at least one of the first alignment hole groups is aligned with at least one of the second alignment hole groups to form at least one insertion space, and a portion of each of the at least one elastic member is located in the corresponding at least one insertion space and connected to the first bracket and the second bracket.

2. The support structure according to claim 1, wherein the first bracket comprises a first head portion and a first neck portion that are connected to each other, the second bracket comprises a second head portion and a second neck portion that are connected to each other, the second neck portion is connected to the first neck portion along the first axis, and when the second bracket is connected to the first bracket, the second neck portion is connected to the first neck portion.

3. The support structure according to claim 2, wherein each of the first alignment hole groups comprises two first openings corresponding to each other, each of the second alignment hole groups comprises two second openings corresponding to each other, the first alignment hole groups are located at the first neck portion, and the second alignment hole groups are located at the second neck portion.

4. The support structure according to claim 2, wherein a width of the first neck portion is greater than a width of the second neck portion, and when the second bracket is connected to the first bracket, at least a portion of the second neck portion is disposed through the first neck portion.

5. The support structure according to claim 2, wherein when the support structure is in a first state, the second neck portion of the second bracket completely extends into the first neck portion of the first bracket, and when the support structure is in a second state, a portion of the second neck portion of the second bracket extends into the first neck portion of the first bracket.

6. The support structure according to claim 5, wherein the length of the support structure in the first state along the first axis is less than the length of the support structure in the second state along the first axis.

7. The support structure according to claim 2, wherein a width of the first head portion is greater than a width of the first neck portion, a width of the second head portion is greater than a width of the second neck portion, and the width of the first head portion is equal to the width of the second head portion.

8. The support structure according to claim 1, further comprising an auxiliary member detachably connected to the first bracket, wherein the auxiliary member comprises a plurality of first auxiliary apertures and a plurality of second auxiliary apertures, and the first auxiliary apertures correspond to the second auxiliary aperture.

9. The support structure according to claim 8, wherein the auxiliary member is connected to the first bracket, and the second bracket is connected to the first bracket, at least one of the first alignment hole groups, at least one of the second alignment hole groups, at least one of the first auxiliary apertures, and at least one of the second auxiliary apertures are aligned with one another to form the corresponding at least one insertion space, and a portion of the at least one elastic member is located in the corresponding at least one insertion space.

10. The support structure according to claim 8, wherein the first bracket comprises a first head portion and a first neck portion that are connected to each other, and the auxiliary member is detachably connected to the first neck portion of the first bracket.

11. The support structure according to claim 8, wherein the auxiliary member comprises a first auxiliary member and a second auxiliary member, the first auxiliary member and the second auxiliary member are detachably connected to the first bracket along a second axis, and when the first auxiliary member and the second auxiliary member are connected to the first bracket, at least a portion of the first bracket is located between the first auxiliary member and the second auxiliary member, and the first axis is perpendicular to the second axis.

12. The support structure according to claim 11, wherein the first bracket comprises two second limiting members, the first auxiliary member comprises a second limiting groove, and the second auxiliary member comprises a third limiting groove, and when the first auxiliary member and the second auxiliary member are connected to the first bracket, one of the two second limiting members is at least partially located in the second limiting groove, and the other of the two second limiting members is partially located in the third limiting groove.

13. The support structure according to claim 12, wherein when the support structure is in a first state, one of the two second limiting members is completely located in the second limiting groove, and the other of the two second limiting members is completely located in the third limiting groove, and when the support structure is in a second state, one of the two second limiting members is located in the second limit groove, and the other of the two second limiting members is located in the third limiting groove.

14. The support structure according to claim 11, wherein the first auxiliary apertures are located on the first auxiliary member, and the second auxiliary apertures are located on the second auxiliary member.

15. The support structure according to claim 8, wherein each of the at least one elastic member comprises an elastic member body, two elastic arms, and two hook portions, the two elastic arms are connected to the elastic member body, the two hook portions are respectively connected to the corresponding two elastic arms, and the two hook portions are adapted to be engaged with the auxiliary member.

16. The support structure according to claim 15, wherein when the at least one elastic member is connected to the first bracket, the second bracket, and the auxiliary member, the two hook portions are exposed to the auxiliary member.

17. The support structure according to claim 15, wherein the auxiliary member comprises the first auxiliary apertures and the second auxiliary apertures, each of the first auxiliary apertures comprises an inner wall, and when each of the at least one elastic member is connected to the auxiliary member, the elastic member body abuts the inner wall.

18. The support structure according to claim 1, further comprising two expansion members, wherein the two expansion members are connected to the first bracket and the second bracket respectively, a width of each of the two expansion members along a second axis is greater than a width of the first bracket along the second axis and is greater than a width of the second bracket along the second axis, and the first axis is perpendicular to the second axis.

19. The support structure according to claim 18, wherein the first bracket comprises a first head portion and a first neck portion that are connected to each other.

20. The support structure according to claim 1, wherein the first bracket comprises at least one first limiting groove, the second bracket comprises at least one first limiting member, and when the second bracket is connected to the first bracket, at least a portion of the at least one first limiting member is located in the corresponding at least one first limiting groove.
